(19) United States
(12) Patent Application Publication
(10) Pub. No.: US 2001/0048059 A1
(43) Pub. Date: Dec. 6, 2001

(54) Portable easel assembly

(76) Inventor: Donald Richard Jones II, Burbank, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 09/870,208

(22) Filed: May 30, 2001

Related U.S. Application Data
(60) Provisional application No. 60/208,400, filed on May 30, 2000.
(60) Provisional application No. 60/232,959, filed on Sep. 14, 2000.

(51) Int. Cl. F16M 11/00; A47B 97/04

(52) U.S. Cl. 248/461; 248/163.1; 248/161

(57) ABSTRACT

A portable easel assembly includes a tripod assembly and a paint/sketch box. A lid is connected to a base of the paint/sketch box by a hinge assembly and a slide bar assembly having a slide bar slidably interconnected to the base and lid and secured in position with clamps. The tripod assembly includes an attachment plate having an aperture configured to receive a bolt therethrough. A first leg is pivotally attached to the attachment plate so as to be moveable between an extended supportive position and a folded position. Second and third legs are associated with the attachment plate in such a manner so as to be rotatable and pivoted between supportive and folded positions. The first, second and third legs are adjustable in length.

### RELATED APPLICATION

This application claims priority from provisional application Ser. No. 60/208,400 filed May 30, 2000, and provisional application Ser. No. 60/232,959 filed Sep. 14, 2000.

### BACKGROUND OF THE INVENTION

The present invention generally relates to artist easels. More particularly, the present invention relates to a portable easel assembly including a paint/sketch box constructed to allow a painter to adjust and set a canvas bearing portion of the box in various position and angles, and a tripod assembly which is constructed so as to allow flat based objects of relatively large dimension, such as the paint/sketch box, to be stably mounted thereon in a quick and facile manner, as well as being foldable into a nearly flat configuration so as to allow easy and compact transportation and storage.

Paint box easels have been in existence for hundreds of years. Their purpose is to allow an artist to work outside of the convenience of a studio. They are constructed much like a briefcase or a laptop computer, having two halves hinged at the back that can be laid flat and opened up. The first bottom half or base holds the artist's materials such as paint tubes, brushes, medium and thinner. The second vertically extending half or lid is similar to a picture box with slots extending along the length of both sides of the box and designed to hold whatever surface the artist wishes to create images on, usually pre-cut canvas board. This lid is the easel area of the paint box. The slots recede in series to allow multiple works to be transported and worked on with a front slot within the base capable of housing a palette board for paints to be mixed on.

Convenience, portability and efficiency are the attractions of a paint box easel. The artist may rest the box on his lap to make studies and sketches in public places. He may sit low on a rock or stool and open the box on the ground for landscape painting. Many a novice or student has been enchanted by the possibilities of a paint box easel only to discover its use to be quite limited.

The major difficulty is that the box is hinged at the back in the traditional manner. This creates a balance problem causing the easel area to tip back when any slightly vigorous brushwork is attempted. This can mar the work and cause open bottles of medium and thinner to spill. The artist is not enthused by having to steady the box with one hand and paint with the other. Furthermore, in oil painting the rule is three strokes and you are out, meaning the now muddied paint must be pulled from the brush with a rag. Cleaning, dipping, mixing, switching brushes, requires both hands to be used to clean the brush, thus removing the hand which has been steadying the paint box.

A further problem is caused by the traditional use of a support that holds the lid of the easel box at a fixed angle (unless one hand tips the box back and holds it in position). If the artist wants the painting surface to be flat so a wash can be laid down and controlled he or she must empty the contents of the box and lay the easel, side down, or remove the canvas from the paint box and hold it level while trying to apply the wash. A landscape painter cannot change his position in response to a need to adjust to the sun's position because a glare is coming off of his wet canvas. That would alter his point of view. Instead, he or she must change the angle or height of his or her work. Accessibility to painting materials is limited or completely restricted in prior paint boxes when the palette is resting on top of the open box bottom.

Paint box easels are often mounted to a tripod. Tripods have traditionally been constructed so as to attach to small and delicate objects of little weight such as cameras and engineer's surveying equipment. Tripods engineered for heavy objects involve complex custom fittings and great expense.

An artist's portable box easel normally comes in two forms. There is the type known as a French easel that is a box with a folding leg attached to each side and a third leg folded into a cavity in the bottom middle of the box. The other type is commonly called a Pochade box or paint/sketch box easel. It is normally designed to be opened up on a table or other flat surface and used at the height it is set on. Attempts have been made to manufacture the Pochade box type easel with a threaded insert fitted into the bottom of the box so as to receive the threaded knob clamp from a standard camera tripod and thus be mounted for height adjustment and used in the same manner as the French easel. This arrangement requires that the box be quite limited in size and weight or it will overwhelm the camera tripod and wobble at the slightest touch.

A further problem is caused by the length and awkward position of the standard ¼-20 threaded knob clamp used by the camera tripod industry. Since a camera is a relatively light and delicate instrument it comes with a threaded insert of very little depth and the knob clamp mounted to the tripod need only be a nub above the mounting surface to attach itself. This makes the attachment of the camera a somewhat delicate and fussy act, and generally requires that such a tripod's attachment to an artist's paint box involves having to invert the box and control the tripod in an awkward upside-down position. The tripod industry is aware of this problem and offers a quick release plate on some tripod models that first attaches to the camera and then attaches to the tripod itself, but they add to the tripod's expense, only make the attachment somewhat easier, and add nothing to the stability of a large based object such as the artist's box easel.

The French easel with its folding legs does provide a stable surface, but unfolding and extending each leg while supporting the easel itself can resemble a clumsy wrestling match. The French easel also tends to be larger and heavier than the Pochade/sketch/paint box easel. This is because the folding legs require a certain amount of space in order to store themselves and still open up with enough length to accommodate an artist creating her or his work in the standing position. Size and weight are key considerations for both the landscape painter and the art school student who must transport their art supplies to a variety of locations in order to create their art.

Accordingly, there is a need for an improved paint box which holds artist's materials and canvas boards similar to a traditional paint box, but which allows the artist to adjust the position and angle of the lid of the paint box. What is also needed is a paint box that allows the artist to conveniently access his or her supplies while mixing colors and painting. What is further needed is an improved tripod assembly that is easily transportable due to its collapsible design and configuration. Such a tripod assembly should be easily attached to any reasonably sized flat bottom container, such as a sketch/paint box, while providing a secure and stable base once attached. The present invention fulfills these needs and provides other related advantages.

### SUMMARY OF THE INVENTION

The present invention resides in a portable easel assembly comprising a container, such as a paint/sketch box, which is releasably attachable to a tripod assembly. The tripod assembly is collapsible into a closed position, and the paint/sketch box is designed such that the artist can adjust the position and angle of a lid of the box while conveniently accessing his or her supplies within the box.

The tripod assembly comprises an attachment plate having an aperture through which a hand knob assembly, i.e., a hand knob with a clamping screw cast securely in place or an externally threaded post clamp as used for the slidebars, is insertable. Typically, the aperture comprises an open-faced slot extending from an edge of the attachment plate towards the center of the attachment plate. A first leg is pivotally attached to the attachment plate so as be movable between an extended supportive position, and a folded position. Second and third legs are associated with the attachment plate so as to be rotatable between supportive and folded positions. The first, second and third legs are typically adjustable in length.

A support plate is attached to each of the first, second and third legs so as to be positionable over the attachment plate when the legs are in their extended, supportive positions such that the paint/sketch box rests thereon. Edges of the attachment plate are beveled to position the legs at a predetermined supportive angle. Swivel plates are rotatably connected to the attachment plate and pivotally connected to the second and third legs so as to facilitate their rotation between the supportive and folded positions.

The container supported by the tripod assembly may vary, but preferably comprises the paint/sketch box that includes a base configured to releasably attach to the attachment plate. The base typically has a hand-tightened bolt-accepting aperture therethrough for attachment to the tripod assembly. A lid is connected to the base by a hinge assembly and a slide bar assembly.

The hinge assembly comprises a first brace attached to a rear surface of the base and extending upwardly to a point above a top edge of the base. A second brace is attached to the top surface of the lid, and a third brace is pivotally connected at one end thereof to the first brace, and to the second brace at the opposite end thereof.

The slide bar assembly includes a slide bar slidably interconnected to the base and lid and secured in position with clamps. The slide bar includes a slot extending substantially along the length thereof. The clamp comprises externally threaded posts extending from the base and lid and into the slide bar slot. Hand-actuatable knobs are configured to be threaded onto each post and into contact with the slide bar to hold the slide bar in place.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompany drawings illustrate the invention. In such drawings:

FIG. 1 is a perspective view of a portable easel assembly embodying the present invention and including a paint/sketch box attached to a tripod assembly;

FIG. 2 is a partially exploded perspective view of the assembly of FIG. 1, illustrating the paint/sketch box removed from the tripod assembly;

FIG. 3 is an exploded view of the paint/sketch box of FIG. 1, illustrating the various component parts thereof;

FIG. 4 is a side elevational view of the paint/sketch box in a closed state;

FIG. 5 is a side elevational view of the paint/sketch box of FIG. 4 partially opened;

FIG. 6 is a side elevational view of the paint/sketch box of FIGS. 4 and 5 in a fully opened state;

FIG. 7 is a rear elevational view taken generally along line 7-7 of FIG. 6;

FIG. 8 is an exploded perspective view of the tripod assembly of FIG. 1, illustrating the various components thereof;

FIG. 9 is a side elevational view of the tripod assembly in an inverted position;

FIG. 10 is a side elevational view of the tripod assembly of FIG. 9, illustrating the rotation of two legs thereof as a first step in collapsing the tripod assembly;

FIG. 11 is a side elevational view of the tripod assembly of FIG. 10, illustrating the two legs being pivoted downwardly;

FIG. 12 is a side elevational view of the tripod assembly of FIG. 11, illustrating the two legs completely folded;

FIG. 13 is a side elevational view of the tripod assembly with a third leg pivoted into a completely folded position; and

FIG. 14 is a top plan view taken generally along line 14-14 of FIG. 13, and illustrating the tripod assembly in a fully collapsed state.

### DETAILED DESCRIPTION OF THE PREFERRED EMBODIMENT

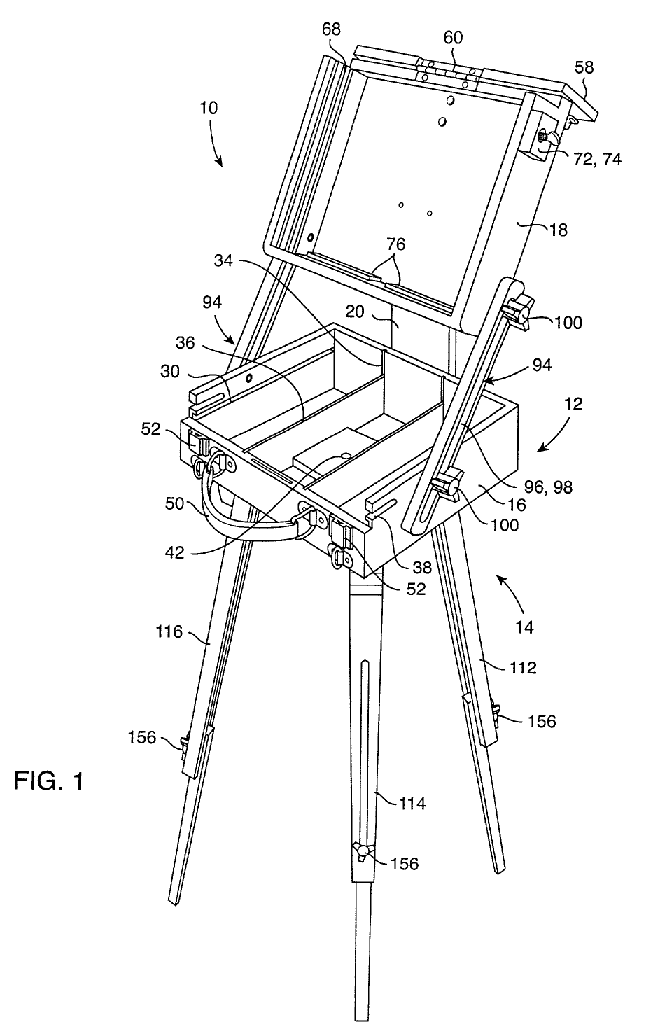

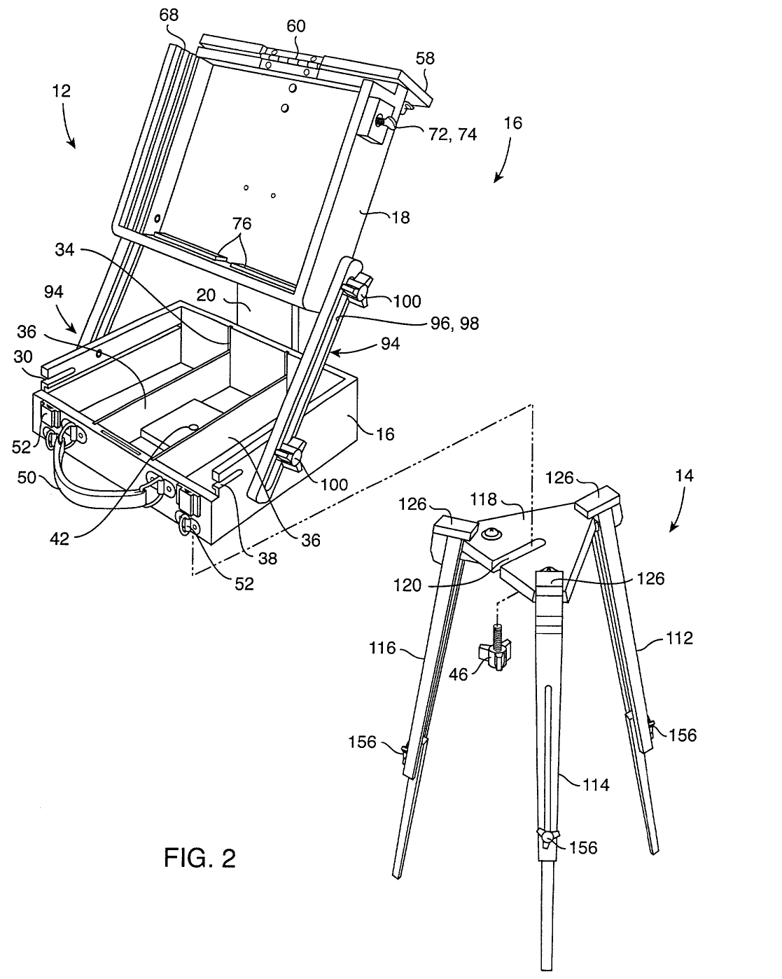

As shown in the drawings for purposes of illustration, the present invention is concerned with a portable easel assembly, generally referred to in the figures by the reference number 10. The assembly 10 is generally comprised of a paint/sketch box 12 removably attached to a tripod assembly 14, as shown in FIGS. 1 and 2.

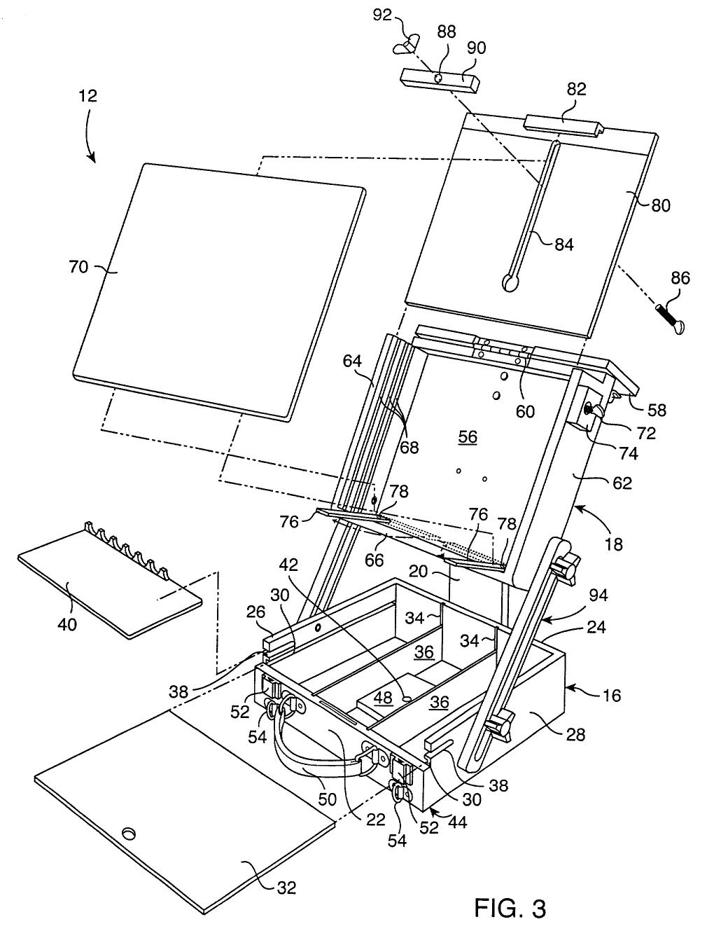

With reference now to FIG. 3, the paint/sketch box 12 is comprised of a base 16 connected to a lid 18 by a hinge assembly 20. The base 16 includes a front wall 22, a back wall 24, and opposing side walls 26 and 28 which form an open-faced square containment area therebetween. Horizontal slots 30 are formed in each of the side walls 26 and 28 so as to be parallel and generally aligned with one another. A pallet 32, such as a wood or glass paint mixing pallet, is insertable into the slots 30 so that the artist can conveniently mix paints, use the pallet 32 as a shelf, and cover the contents of the base 16.

Vertical slots 34 are formed opposite one another in the front and back walls 22 and 24 of the base 16 for insertion of slats 36 which serve to compartmentalize the base 16 in order to separate tubes of paint, rags, brushes, etc. placed within the base 16.

Open-faced apertures 38 are formed in front edges of the side walls 26 and 28 above the front wall 22. These apertures 38 extend into the side walls 26 and 28 a predetermined distance to allow platforms 40, such as the illustrated brush holding platform, to be inserted therein sufficiently to be adequately supported.

An internally threaded aperture 42 is formed in a bottom wall 44 of the base 16 for releasable attachment to the tripod assembly 14 via a hand-actuatable bolt 46 Which is inserted through the tripod assembly 14 and into the aperture 42, as will be more fully discussed herein. Preferably, the aperture 42 extends through the bottom wall 44 and into a block 48 which provides added strength and support.

Typically, the base 16 includes a handle 50 used to carry the paint/sketch box 12, lower portions of clamps 52 used to clamp shut the paint/sketch box 12, and metal rings 54 which can be used to strap the paint/sketch box 12 and tripod assembly 14 together for transport.

The lid 18 includes a top wall 56, a front wall 58 which is formed in two segments connected by a hinge 60 to create a door. Opposing side walls 62 and 64 interconnect the front wall 58 with a back wall 66 of the lid 18. A series of opposing slits 68 are formed in the side walls 62 and 64 of the lid 18 for insertion of pre-cut canvas boards 70 or the like. A hand-actuatable bolt 72 extends through a block 74 attached to the side wall 62 which can be extended into a slot 68 so as to securely hold the canvas board 70 in place while the artist is painting, or when used with the support board 80, be used to change the height of the support board and accommodate canvases larger than the box itself. The support legs 76 are supporting the bottom of the larger canvas when used this way. The support legs 76 are attached to the interior side of the back wall 66 by a screw 78 or bolt inserted through one end of the support leg which serves as a pivot point so that the support leg 76 can be pivoted outwardly to support the canvas board 70 inserted within the slots 68 of the lid 18.

A support board 80 is configured to be insertable into the slots 68, and includes a stop 82 attached to one end thereof, and an elongated slot 84 extending vertically at approximately the mid-line thereof and configured to receive a bolt 86 which is insertable through an aperture 88 of an adjustable stop 90 and secured in place by a wing nut 92. Thus, canvas boards of smaller size can be held in place by placing the canvas board onto the support board 80 and adjusting the position of the adjustable stop 90 along the elongated slot 84 until the canvas board is securely positioned between the stops 82 and 90. This allows the artist to work on a variety of sizes of canvas board 70.

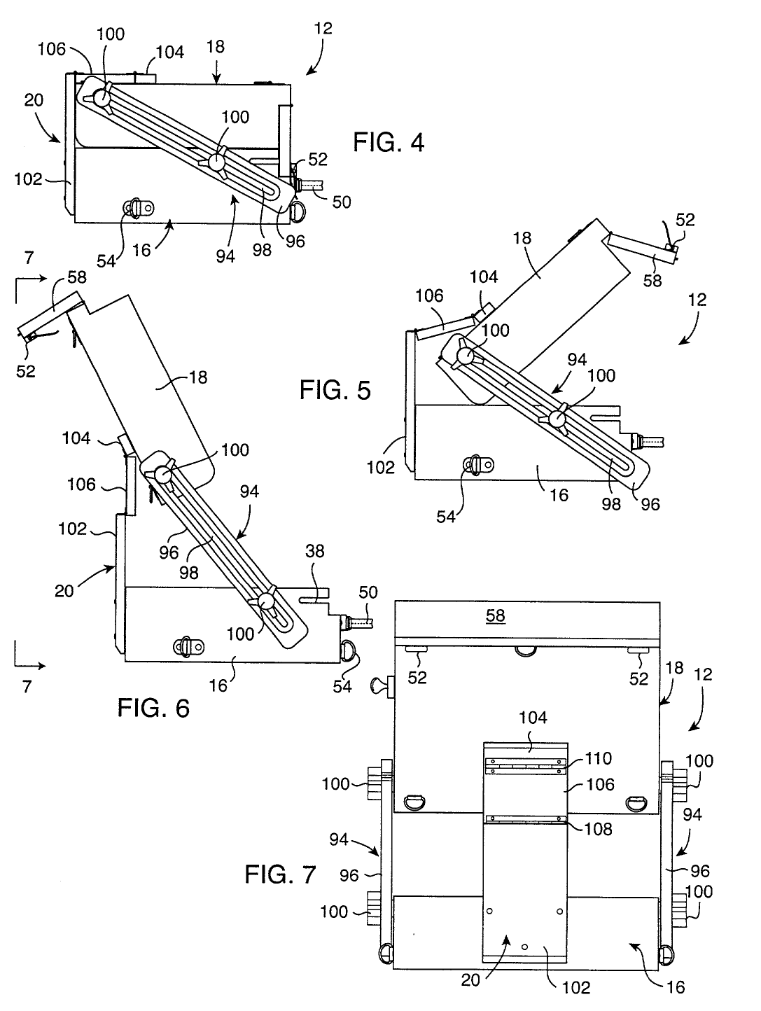

Referring now to FIGS. 4-7, a slide assembly 94 is associated with both the base 16 and lid 18. The slide bar assembly 94 includes a slide bar 96 interconnected to the base 16 and lid 18 by threaded posts (not shown) which extend through a slot 98 substantially extending the length of the slide bar 96. Hand-actuatable knobs 100 are threaded onto the posts such that they can be tightened into contact with the slide bar 96 and prevent the movement thereof, and loosened to permit the slide bar 96 to slide freely.

The previously mentioned hinge assembly 20 comprises a first brace 102 securely attached to the back wall 24 of the base 16 and extending upwardly therefrom to a point above the top wall 56 of the lid 18. The lid 18 is not directly attached to the first brace 102. Instead, a second brace 104 is directly attached to the top wall 56 of the lid 18, and a third brace 106 is pivotally connected at one end thereof to the first brace 102, and pivotally attached to the second brace 104 at an opposite end thereof. This is typically done by attaching a hinge, such as a piano hinge or the like, 108 to the first brace 102 and third brace 106. Similarly, another hinge 110 is attached to the second brace 104 and opposite end of the third brace 106. It is important to know that the third brace 106 is not connected directly to either the base 16 nor lid 18, but rather is allowed to freely move. The two separate hinge points allow the lid 18 to be moved to a nonadjacent plane. This allows the lid 18 to lift up and away from the base 16 in a serpentine motion that can be arrested at any position from straight up to perfectly flat, as illustrated in FIGS. 4-6, or at varying distance separation and angles and locked into position by tightening the knobs 100 against the slide bar 96 to prevent the lid 18 from being moved from position. Preferably, a bottom and rear edge of the lid 18 is rounded to facilitate opening of the lid 18 from the base 16.

In use, the clamps 52 on the front wall 22 of the base 16 and the front wall 58 of the lid 18 are disengaged. The knobs 100 are loosened from the posts extending from each side wall 26 and 28 of the base 16, as well as the posts extending from the side walls 62 and 64 of the lid 18 so as to allow the slide bar 96 to move. The lid 18 is then lifted from the base 16 and placed at the desired height and angle, as illustrated in FIGS. 5 and 6. The knobs 100 are then tightened on the threaded posts against the slide bars 96 to hold the lid 18 in place. The door 58 of the lid 18 can then be opened to permit access to the slots 68 in which the canvas board 70 or support board 80 reside. The door 58 also presents an advantage when the base 16 and lid are closed in that the artist can retrieve the canvas board 70, or other supplies, without the need to completely open the box 12. In the event that the lid 18 needs to be adjusted, the knobs 100 are simply loosened so that the slide bar 96 can be moved while the lid 18 is readjusted in height or angle.

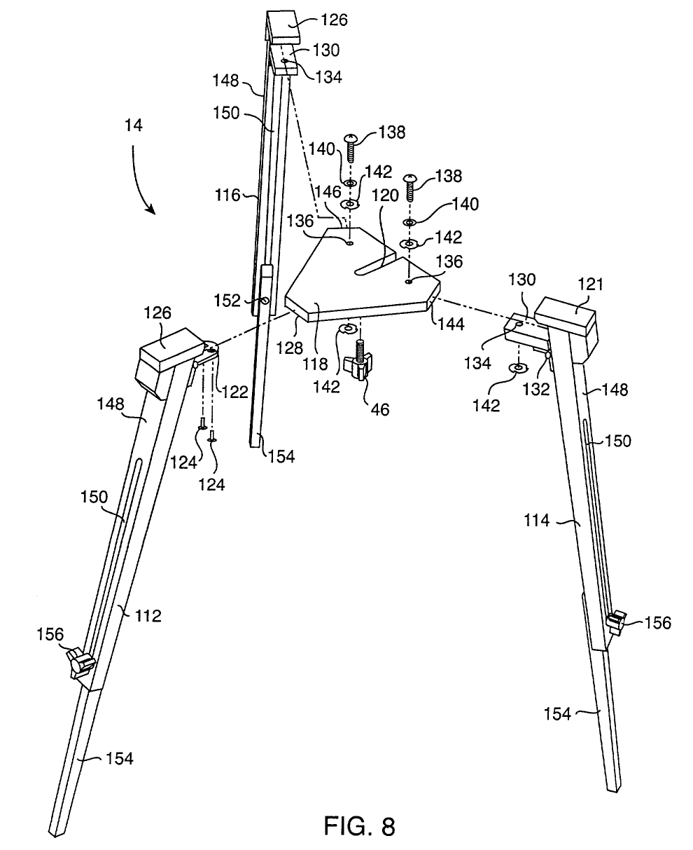

Referring now to FIG. 8, the component parts of the tripod assembly 14 are shown. The tripod assembly 14 is generally comprised of three legs 112-116, associated with an attachment plate 118. The attachment plate 118 is preferably triangular in shape, with the corners removed and beveled to a predetermined angle. An open-faced slot 120 extends from one edge of the attachment plate 118 towards the central portion of the attachment plate 118 and is configured and sized so as to receive the bolt 46 therethrough and into the base aperture 42 of the paint/sketch box 12. The purpose of the slot 120 in the attachment plate 118 is to allow one to thread the hand knob or bolt 46 into the bottom of the box 12 and then slide the attachment plate 118 into position before tightening the hand knob bolt 46. While the tripod assembly 14 is particularly adapted for use with the paint/sketch box 12, it is to be understood that the tripod assembly 14 is also suitable for use with any container or object having a relatively flat base that extends across the surface of the attachment plate 118 and includes an internally threaded aperture, or other appropriate clamping means for attaching the object to the tripod assembly 14.

Leg 112 is connected to the attachment plate 118 by a hinge 122 which is attached to the leg 112 and attachment plate 118 by screws 124 in a traditional manner. The hinge 122 allows the leg 112 to be extended to the appropriate angle and pivoted over the attachment plate 118 for transport and storage purposes. A support plate 126 is attached to the uppermost end of the leg 112 and positionable over the attachment plate 118 when the leg 112 is in its extended, and supportive position. The support plate 126 is set at an angle to match the beveled corner 128, typically 15°, so that the leg 112 extends outwardly at that angle. With the support plates 126 positioned on the attachment plate 118, the object or container in question, typically the paint/sketch box 12, can be placed thereon and bolt 46 tightened through internally threaded base aperture 42 until an appropriate and equal tension is achieved across all three support plates 126.

Legs 114 and 116 are not hinged directly to the attachment plate 118, but rather are each connected to a swivel plate 130 via hinge 132. The swivel plates 130 each include an aperture 134 therethrough which is alignable with an aperture 136 extending through the attachment plate 118. A bolt 138 extends through the aligned apertures 134, 136 to rotatably connect the aperture plate 118 with the legs 114 and 116. Washers 140 and t-nuts 142 hold the bolts 138 in place while allowing the swivel plate 130 to be rotated about the bolts 138. This arrangement allows the hinges 132 to limit the outward movement of the legs 1 14 and 1 1 6 to their desired open position, and at the same time allow legs 114 and 116 to fold flat against the attachment plate 118 and turn on the axis of the bolt 138 in a position aligned with and parallel to the flat resting position of leg 112 when it is folded upon the attachment plate 118, as more fully described herein. Legs 114 and 116 also include a support plate 126 attached to an upper surface thereof and placed at an angle cooperating with the beveled edge 144 and 146, preferably beveled at approximately 15°, so that the legs 112-116 splay outward in a supportive arrangement.

All three legs 112-116 are adjustable in length. Although there are many means of accomplishing this, in the illustrated embodiment an upper portion 148 of each leg 112-116 includes an elongated slot 150 through which a post 152 extending from a lower portion 154 of the leg 112-116 is inserted. A hand-actuatable tension clamp 156 is threaded onto the post 152 so that the lower portion 154 can be moved to the appropriate and desired height, and tightened in place by threading tension knob 156 onto the post 152 such that the tension knob 156 frictionally contacts the upper portion 148 of the leg 112-116. The lower portion 154 of the leg 112-116 can be completely retracted and collapsed by loosening tension knob 156 and sliding the lower portion 154 upwardly until the post 152 is positioned at the uppermost end of the slot 150, or the lower end of the upper portion 148 and the lower end of the lower portion 154 are aligned.

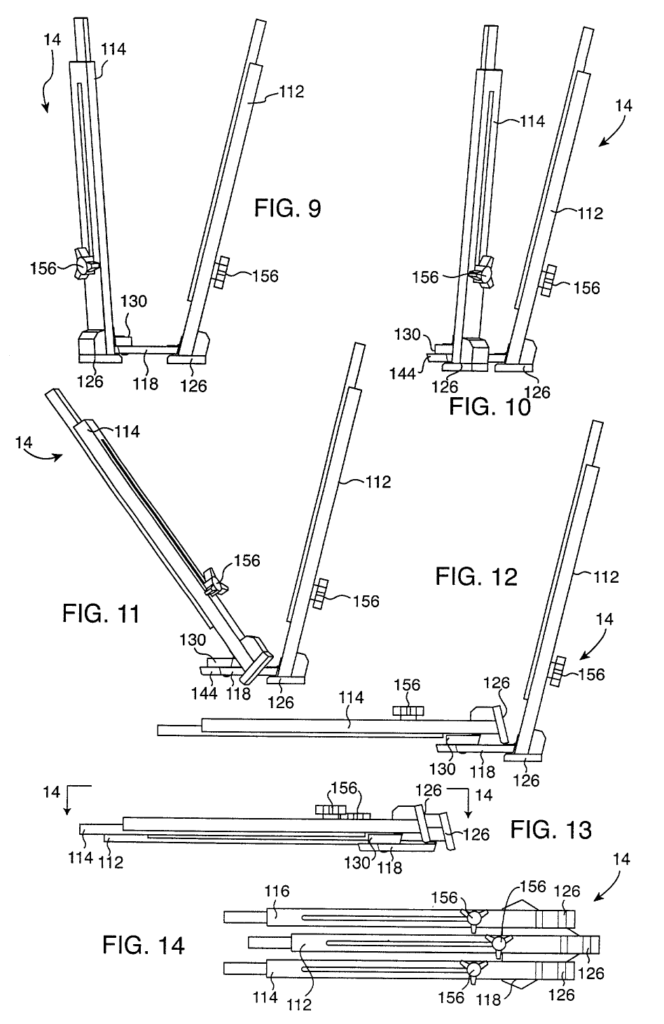

Referring now to FIGS. 9-14, the tripod assembly 14 can be collapsed and folded upon itself in a relatively flat arrangement. This final arrangement is achieved by rotating legs 114 and 116 away from beveled edges 144 and 146 and towards leg 112, as illustrated in FIG. 10. Legs 114 and 116 are then pivoted by folding the legs 114 and 116 on their hinges 132 until they lie generally flat and horizontal, as illustrated in FIG. 12. Leg 112 is then pivoted by folding it at its hinge 122 over the attachment plate 118 so as to be positioned between the previously folded legs 114 and 116. The tripod assembly 14 is now ready for easy transport and compact storage. The collapsed tripod assembly 14 can be carried with the paint/sketch box 12 by using bungy cord, rope, or the like to wrap the legs 112-116 tightly to the box 12 using the previously mentioned ring clips 54. In this manner, the artist can use the handle 50 of the box 12 to carry the entire assembly 10.

The tripod assembly 14 is advantageous as the user can quickly and conveniently attach a relatively large flat base object, such as the artist paint/sketch box 12, or other display boxes, to the tripod assembly 14 in a secure and stable configuration. Yet, it is very easy to remove or dismount the box 12 and collapse the tripod assembly 14 for transport. The design of the tripod assembly 14 is efficient in that it contains relatively few parts, thus rendering it relatively inexpensive to manufacture.

Although several embodiments have been described in detail for purposes of illustration, various modifications may be made without departing from the scope and spirit of the invention. Accordingly, the invention is not to be limited, except as by the appended claims.

What is claimed is:

1. A portable easel assembly, comprising:
a tripod assembly including an attachment plate having an aperture therethrough, a bolt insertable through the attachment plate aperture, a first leg pivotally attached to the attachment plate so as to be movable between an extended supportive position and a folded position, and second and third legs associated with the attachment plate so as to be rotatable and pivotable between supportive and folded positions; and
a paint/sketch box including a base configured to accept the bolt for releasable attachment of the box to the attachment plate, and a lid connected to the base by a hinge assembly and a slide bar assembly.

2. The assembly of claim 1, including swivel plates rotatably connected to the attachment plate and pivotally connected to the second and third legs.

3. The assembly of claim 1, including a support plate attached to each of the first, second and third legs and positionable over the attachment plate when the first, second and third legs are in their extended, supportive positions such that the box rests thereon.

4. The assembly of claim 1, wherein the attachment plate aperture comprises an open-faced slot extending from an edge of the attachment plate towards the center of the attachment plate.

5. The assembly of claim 1, wherein edges of the attachment plate are beveled to position the first, second and third legs at a predetermined supportive angle.

6. The assembly of claim 1, wherein the first, second and third legs are adjustable in length.

7. The assembly of claim 1, wherein the hinge assembly comprises a first brace attached to a rear surface of the base and extending upwardly to a point above a top edge of the base, a second brace attached to a top surface of the lid, and a third brace pivotally connected at one end thereof to the first brace and pivotally attached to the second brace at an opposite end thereof.

8. The assembly of claim 1, wherein the slide bar assembly includes a slide bar slidably interconnected to the base and lid and releasably secured in position with clamps.

9. The assembly of claim 8, wherein the slide bar includes a slot substantially extending the length thereof, and the clamp comprises externally threaded posts extending from the base and lid and into the slide bar slot, and hand-actuatable knobs configured to be threaded onto the posts and into contact with the slide bar.

10. A portable easel assembly, comprising:
a paint/sketch box including a base and a lid connected to the base by a hinge assembly;
a slide bar assembly including a slide bar slidably interconnected to the base and lid and secured in position with clamps; and
a tripod assembly releasably attached to the paint/sketch box.

11. The assembly of claim 10, wherein the hinge assembly comprises a first brace attached to a rear surface of the base and extending upwardly to a point above a top edge of the base, a second brace attached to a top surface of the lid, and a third brace pivotally connected at one end thereof to the first brace and pivotally attached to the second brace at an opposite end thereof.

12. The assembly of claim 10, wherein the slide bar includes a slot substantially extending the length thereof, and the clamp comprises externally threaded posts extending from the base and lid and into the slide bar slot, and hand-actuatable knobs configured to be threaded onto the posts and into contact with the slide bar.

13. The assembly of claim 10, wherein the tripod assembly includes a bolt extending therefrom and insertable into an aperture formed in the base of the paint/sketch box.

14. The assembly of claim 13, wherein tripod assembly includes an aperture through an attachment plate thereof for insertion of the bolt through the attachment plate and into the base aperture of the box, a first leg pivotally attached to the attachment plate sodas to be movable between an extended supportive position and a folded position, and second and third legs associated with the attachment plate in such a manner so as to be rotatable and pivotable between supportive and folded positions.

15. The assembly of claim 14, including swivel plates rotatably connected to the attachment plate and pivotally connected to the second and third legs.

16. The assembly of claim 14, including a support plate attached to each of the first, second and third legs and positionable over the attachment plate when the first, second and third legs are in their extended, supportive positions such that the box rests thereon.

17. The assembly of claim 14, wherein the attachment plate aperture comprises an open-faced slot extending from an edge of the attachment plate towards the center of the attachment plate.

18. The paint/sketch easel assembly of claim 14, wherein edges of the attachment plate are beveled to position the first, second and third legs at a predetermined supportive angle.

19. The paint/sketch easel assembly of claim 14, wherein the first, second and third legs are adjustable in length.

20. A portable easel assembly, comprising:
a tripod assembly including:
an attachment plate;
a first leg pivotally attached to the attachment plate so as to be movable between an extended supportive position and a folded position;
second and third legs associated with the attachment plate so as to be rotatable and pivotable between supportive and folded positions; and
a container releasably attachable to the attachment plate.

21. The assembly of claim 20, including swivel plates rotatably connected to the attachment plate and pivotally connected to the second and third legs.

22. The assembly of claim 20, including a support plate attached to each of the first, second and third legs and positionable over the attachment plate when the first, second and third legs are in their extended, supportive positions such that the container rests thereon.

23. The assembly of claim 20, wherein the attachment plate includes an aperture configured to receive a bolt therethrough and into an aperture of the container to releasably attach the container to the attachment plate.

24. The assembly of claim 23, wherein the attachment plate aperture comprises an open-faced slot extending from an edge of the attachment plate towards the center of the attachment plate.

25. The assembly of claim 20, wherein edges of the attachment plate are beveled to position the first, second and third legs at a predetermined supportive angle.

26. The assembly of claim 20, wherein the first, second and third legs are adjustable in length.

27. The assembly of claim 20, wherein the container supported by the tripod assembly comprises a paint/sketch box including a base having a bolt-accepting aperture therethrough and a lid connected to the base by a hinge assembly and a slide bar assembly.

28. The assembly of claim 27, wherein the hinge assembly comprises a first brace attached to a rear surface of the base and extending upwardly to a point above a top edge of the base, a second brace attached to a top surface of the lid, and a third brace pivotally connected at one end thereof to the first brace and pivotally attached to the second brace at an opposite end thereof.

29. The assembly of claim 27, wherein the slide bar assembly comprises a slide bar slidably interconnected to the base and lid and secured in position with clamps.

30. The assembly of claim 29, wherein the slide bar includes a slot substantially extending the length thereof, and the clamp comprises externally threaded posts extending from the base and lid and into the slide bar slot, and hand-actuatable knobs configured to be threaded onto the posts and into contact with the slide bar.
